(19) United States
(12) Patent Application Publication
(10) Pub. No.: US 2018/0310201 A1
(43) Pub. Date: Oct. 25, 2018

(54) METHOD FOR TRANSMITTING A HARQ TRANSMISSION IN A WIRELESS COMMUNICATION SYSTEM AND A DEVICE THEREFOR

(71) Applicant: LG ELECTRONICS INC., Seoul (KR)

(72) Inventors: Sunyoung Lee, Seoul (KR); Seungjune Yi, Seoul (KR)

(21) Appl. No.: 15/768,020

(22) PCT Filed: Oct. 26, 2016
(86) PCT No.: PCT/KR2016/012074

§ 371 Date: Apr. 13, 2018

Related U.S. Application Data
(60) Provisional application No. 62/250,543, filed on Nov. 4, 2015.

(51) Int. Cl. H04W 28/04; H04L 1/18

(52) U.S. Cl. CPC H04W 28/04; H04L 1/1874; H04L 1/1812

(57) ABSTRACT

The present invention relates to a wireless communication system. More specifically, the present invention relates to a method and a device for transmitting a HARQ transmission in a wireless communication system, the method comprising: receiving a MAC PDU; performing a HARQ transmission of the MAC PDU; checking whether the HARQ transmission of the MAC PDU is failed or not; and performing a HARQ retransmission procedure of the MAC PDU including one or more HARQ retransmissions, by setting a value of CURRENT_IRV for the MAC PDU to 0 if the UE considers that the HARQ transmission of the MAC PDU is failed.

### TECHNICAL FIELD

The present invention relates to a wireless communication system and, more particularly, to a method for transmitting a HARQ transmission in a wireless communication system and a device therefor.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

### DISCLOSURE

### Technical Problem

An object of the present invention devised to solve the problem lies in a method and device for transmitting a HARQ transmission in a wireless communication system. The technical problems solved by the present invention are not limited to the above technical problems and those skilled in the art may understand other technical problems from the following description.

### Technical Solution

The object of the present invention can be achieved by providing a method for User Equipment (UE) operating in a wireless communication system as set forth in the appended claims.

In another aspect of the present invention, provided herein is a communication apparatus as set forth in the appended claims.

It is to be understood that both the foregoing general description and the following detailed description of the present invention are exemplary and explanatory and are intended to provide further explanation of the invention as claimed.

### Advantageous Effects

In this invention, it is proposed that a MAC entity performs an ACK-based HARQ transmission of a MAC PDU which is already stored in a HARQ buffer if the MAC entity considers the new HARQ transmission of the MAC PDU fails. In other words, if the new HARQ transmission of the MAC PDU is considered fail, the MAC entity does not perform HARQ retransmission of the MAC PDU but performs ACK-based HARQ transmission of the MAC PDU.

It will be appreciated by persons skilled in the art that the effects achieved by the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a diagram showing a network structure of an Evolved Universal Mobile Telecommunications System (E-UMTS) as an example of a wireless communication system;

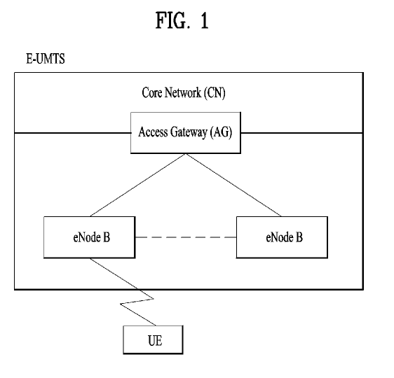

FIG. 2A is a block diagram illustrating network structure of an evolved universal mobile telecommunication system (E-UMTS), and FIG. 2B is a block diagram depicting architecture of a typical E-UTRAN and a typical EPC;

FIG. 3 is a diagram showing a control plane and a user plane of a radio interface protocol between a UE and an E-UTRAN based on a 3rd generation partnership project (3GPP) radio access network standard;

FIG. 4 is a view showing an example of a physical channel structure used in an E-UMTS system;

FIG. 5 is a block diagram of a communication apparatus according to an embodiment of the present invention;

FIG. 6 is a diagram for MAC structure overview in a UE side;

FIG. 7 is a conceptual diagram for uplink grant reception;

FIG. 8 is a diagram for configuring Semi-Persistent Scheduling and configuring skipping uplink transmission; and

FIG. 9 is a conceptual diagram for transmitting and retransmitting a SPS-FB in response to the PDCCH indicating SPS activation or SPS release in a wireless communication system according to embodiments of the present invention.

### BEST MODE

Universal mobile telecommunications system (UMTS) is a 3rd Generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3G LTE requires reduced cost per bit, increased service availability, flexible use of a frequency band, a simple structure, an open interface, and adequate power consumption of a terminal as an upper-level requirement.

Hereinafter, structures, operations, and other features of the present invention will be readily understood from the embodiments of the present invention, examples of which are illustrated in the accompanying drawings. Embodiments described later are examples in which technical features of the present invention are applied to a 3GPP system.

Although the embodiments of the present invention are described using a long term evolution (LTE) system and a LTE-advanced (LTE-A) system in the present specification, they are purely exemplary. Therefore, the embodiments of the present invention are applicable to any other communication system corresponding to the above definition. In addition, although the embodiments of the present invention are described based on a frequency division duplex (FDD) scheme in the present specification, the embodiments of the present invention may be easily modified and applied to a half-duplex FDD (H-FDD) scheme or a time division duplex (TDD) scheme.

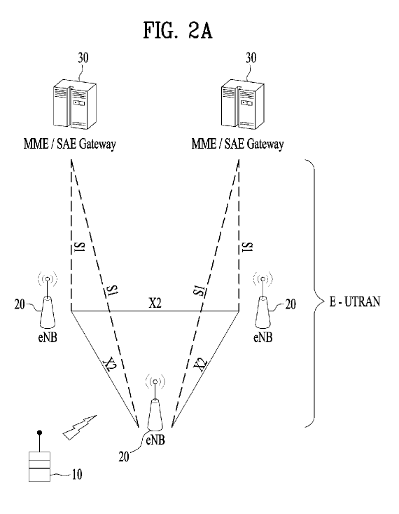

FIG. 2A is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2A, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNodeB 20 to UE 10, and “uplink” refers to communication from the UE to an eNodeB. UE 10 refers to communication equipment carried by a user and may be also referred to as a mobile station (MS), a user terminal (UT), a subscriber station (SS) or a wireless device.

FIG. 2B is a block diagram depicting architecture of a typical E-UTRAN and a typical EPC.

As illustrated in FIG. 2B, an eNodeB 20 provides end points of a user plane and a control plane to the UE 10. MME/SAE gateway 30 provides an end point of a session and mobility management function for UE 10. The eNodeB and MME/SAE gateway may be connected via an S1 interface.

The eNodeB 20 is generally a fixed station that communicates with a UE 10, and may also be referred to as a base station (BS) or an access point. One eNodeB 20 may be deployed per cell. An interface for transmitting user traffic or control traffic may be used between eNodeBs 20.

The MME provides various functions including NAS signaling to eNodeBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, Roaming, Authentication, Bearer management functions including dedicated bearer establishment, Support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNodeB 20 and gateway 30 via the S1 interface. The eNodeBs 20 may be connected to each other via an X2 interface and neighboring eNodeBs may have a meshed network structure that has the X2 interface.

As illustrated, eNodeB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNodeB measurements, radio bearer control, radio admission control (RAC), and connection mobility control in LTE_ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

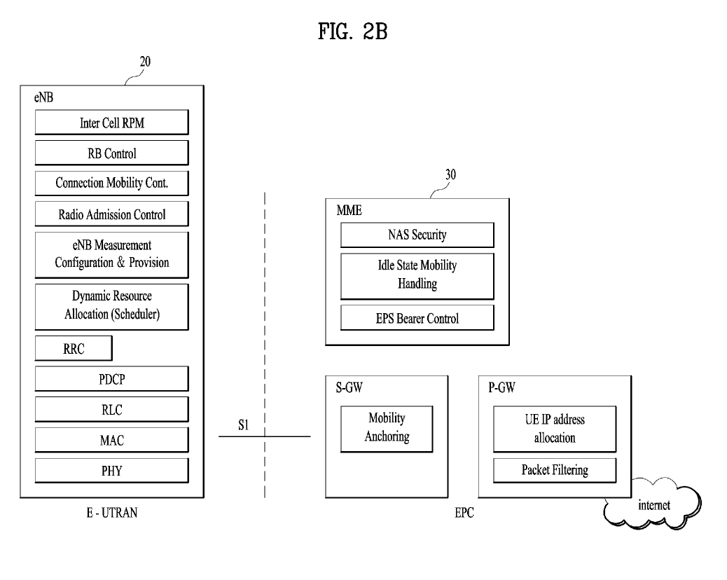

FIG. 3 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on the higher layer via a transport channel Data is transported between the MAC layer and the PHY layer via the transport channel Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

The MAC layer of a second layer provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

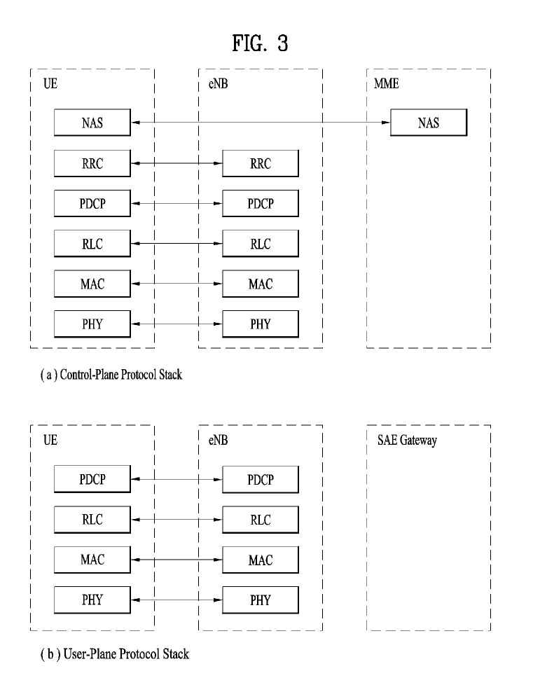

FIG. 4 is a view showing an example of a physical channel structure used in an E-UMTS system. A physical channel includes several subframes on a time axis and several subcarriers on a frequency axis. Here, one subframe includes a plurality of symbols on the time axis. One subframe includes a plurality of resource blocks and one resource block includes a plurality of symbols and a plurality of subcarriers. In addition, each subframe may use certain subcarriers of certain symbols (e.g., a first symbol) of a subframe for a physical downlink control channel (PDCCH), that is, an L1/L2 control channel In FIG. 4, an L1/L2 control information transmission area (PDCCH) and a data area (PDSCH) are shown. In one embodiment, a radio frame of 10 ms is used and one radio frame includes 10 subframes. In addition, one subframe includes two consecutive slots. The length of one slot may be 0.5 ms. In addition, one subframe includes a plurality of OFDM symbols and a portion (e.g., a first symbol) of the plurality of OFDM symbols may be used for transmitting the L1/L2 control information. A transmission time interval (TTI) which is a unit time for transmitting data is 1 ms.

A base station and a UE mostly transmit/receive data via a PDSCH, which is a physical channel, using a DL-SCH which is a transmission channel, except a certain control signal or certain service data. Information indicating to which UE (one or a plurality of UEs) PDSCH data is transmitted and how the UE receive and decode PDSCH data is transmitted in a state of being included in the PDCCH.

For example, in one embodiment, a certain PDCCH is CRC-masked with a radio network temporary identity (RNTI) “A” and information about data is transmitted using a radio resource “B” (e.g., a frequency location) and transmission format information “C” (e.g., a transmission block size, modulation, coding information or the like) via a certain subframe. Then, one or more UEs located in a cell monitor the PDCCH using its RNTI information. And, a specific UE with RNTI “A” reads the PDCCH and then receive the PDSCH indicated by B and C in the PDCCH information.

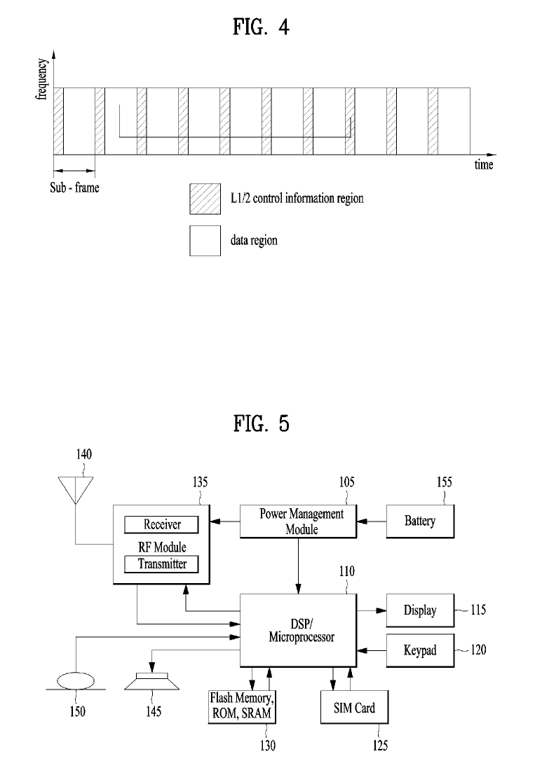

FIG. 5 is a block diagram of a communication apparatus according to an embodiment of the present invention.

The apparatus shown in FIG. 5 can be a user equipment (UE) and/or eNB adapted to perform the above mechanism, but it can be any apparatus for performing the same operation.

As shown in FIG. 5, the apparatus may comprises a DSP/microprocessor (110) and RF module (transmiceiver; 135). The DSP/microprocessor (110) is electrically connected with the transciver (135) and controls it. The apparatus may further include power management module (105), battery (155), display (115), keypad (120), SIM card (125), memory device (130), speaker (145) and input device (150), based on its implementation and designer's choice.

Specifically, FIG. 5 may represent a UE comprising a receiver (135) configured to receive a request message from a network, and a transmitter (135) configured to transmit the transmission or reception timing information to the network. These receiver and the transmitter can constitute the transceiver (135). The UE further comprises a processor (110) connected to the transceiver (135: receiver and transmitter).

Also, FIG. 5 may represent a network apparatus comprising a transmitter (135) configured to transmit a request message to a UE and a receiver (135) configured to receive the transmission or reception timing information from the UE. These transmitter and receiver may constitute the transceiver (135). The network further comprises a processor (110) connected to the transmitter and the receiver. This processor (110) may be configured to calculate latency based on the transmission or reception timing information.

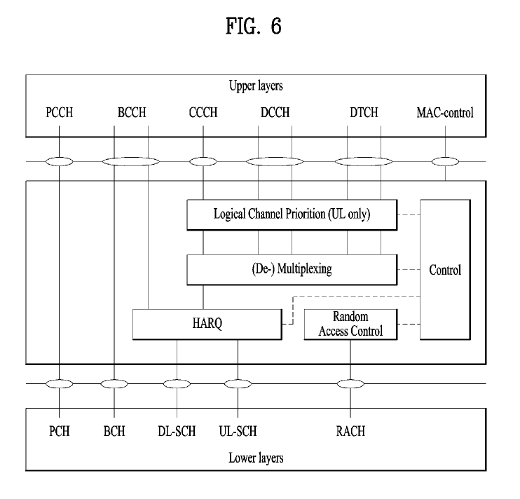

FIG. 6 is a diagram for MAC structure overview in a UE side.

The MAC layer handles logical-channel multiplexing, hybrid-ARQ retransmissions, and uplink and downlink scheduling. It is also responsible for multiplexing/demultiplexing data across multiple component carriers when carrier aggregation is used.

The MAC provides services to the RLC in the form of logical channels. A logical channel is defined by the type of information it carries and is generally classified as a control channel, used for transmission of control and configuration information necessary for operating an LTE system, or as a traffic channel, used for the user data. The set of logical channel types specified for LTE includes Broadcast Control Channel (BCCH), Paging Control Channel (PCCH), Common Control Channel (CCCH), Dedicated Control Channel (DCCH), Multicast Control Channel (MCCH), Dedicated Traffic Channel (DTCH), Multicast Traffic Channel (MTCH).

From the physical layer, the MAC layer uses services in the form of transport channels. A transport channel is defined by how and with what characteristics the information is transmitted over the radio interface. Data on a transport channel is organized into transport blocks. In each Transmission Time Interval (TTI), at most one transport block of dynamic size is transmitted over the radio interface to/from a terminal in the absence of spatial multiplexing. In the case of spatial multiplexing (MIMO), there can be up to two transport blocks per TTI.

Associated with each transport block is a Transport Format (TF), specifying how the transport block is to be transmitted over the radio interface. The transport format includes information about the transport-block size, the modulation-and-coding scheme, and the antenna mapping. By varying the transport format, the MAC layer can thus realize different data rates. Rate control is therefore also known as transport-format selection.

To support priority handling, multiple logical channels, where each logical channel has its own RLC entity, can be multiplexed into one transport channel by the MAC layer. At the receiver, the MAC layer handles the corresponding demultiplexing and forwards the RLC PDUs to their respective RLC entity for in-sequence delivery and the other functions handled by the RLC. To support the demultiplexing at the receiver, a MAC is used. To each RLC PDU, there is an associated sub-header in the MAC header. The sub-header contains the identity of the logical channel (LCID) from which the RLC PDU originated and the length of the PDU in bytes. There is also a flag indicating whether this is the last sub-header or not. One or several RLC PDUs, together with the MAC header and, if necessary, padding to meet the scheduled transport-block size, form one transport block which is forwarded to the physical layer.

In addition to multiplexing of different logical channels, the MAC layer can also insert the so-called MAC control elements into the transport blocks to be transmitted over the transport channels. A MAC control element is used for inband control signaling—for example, timing-advance commands and random-access response. Control elements are identified with reserved values in the LCID field, where the LCID value indicates the type of control information.

Furthermore, the length field in the sub-header is removed for control elements with a fixed length.

The MAC multiplexing functionality is also responsible for handling of multiple component carriers in the case of carrier aggregation. The basic principle for carrier aggregation is independent processing of the component carriers in the physical layer, including control signaling, scheduling and hybrid-ARQ retransmissions, while carrier aggregation is invisible to RLC and PDCP. Carrier aggregation is therefore mainly seen in the MAC layer, where logical channels, including any MAC control elements, are multiplexed to form one (two in the case of spatial multiplexing) transport block(s) per component carrier with each component carrier having its own hybrid-ARQ entity.

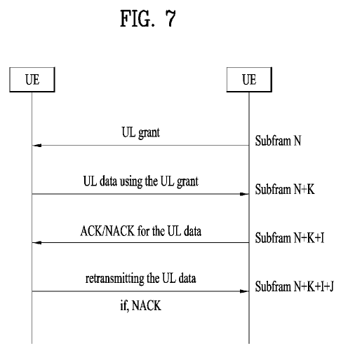

FIG. 7 is a conceptual diagram for uplink grant reception.

In order to transmit on the UL-SCH the MAC entity must have a valid uplink grant (except for non-adaptive HARQ retransmissions) which it may receive dynamically on the PDCCH or in a Random Access Response or which may be configured semi-persistently. To perform requested transmissions, the MAC layer receives HARQ information from lower layers. When the physical layer is configured for uplink spatial multiplexing, the MAC layer can receive up to two grants (one per HARQ process) for the same TTI from lower layers.

When the UE receives a valid uplink grant for transmitting uplink data and for a subframe N+K on a subframe N, the UE transmits the uplink data on a subframe N+K using the uplink grant. And then, the UE receives ACK/NACK feedback for transmission of the uplink data on a subframe N+K+I, and if the UE receives NACK indication, the UE should retransmits the UL data on a subframe N+K+I+J.

In detail, if the MAC entity has a C-RNTI, a Semi-Persistent Scheduling C-RNTI, or a Temporary C-RNTI, the MAC entity shall for each TTI and for each Serving Cell belonging to a TAG that has a running timeAlignmentTimer and for each grant received for this TTI: if an uplink grant for this TTI and this Serving Cell has been received on the PDCCH for the MAC entity's C-RNTI or Temporary C-RNTI; or if an uplink grant for this TTI has been received in a Random Access Response, consider the NDI to have been toggled for the corresponding HARQ process regardless of the value of the NDI if the uplink grant is for MAC entity's C-RNTI and if the previous uplink grant delivered to the HARQ entity for the same HARQ process was either an uplink grant received for the MAC entity's Semi-Persistent Scheduling C-RNTI or a configured uplink grant, and deliver the uplink grant and the associated HARQ information to the HARQ entity for this TTI.

Else, if this Serving Cell is the SpCell and if an uplink grant for this TTI has been received for the SpCell on the PDCCH of the SpCell for the MAC entity's Semi-Persistent Scheduling C-RNTI, the MAC entity considers the NDI for the corresponding HARQ process not to have been toggled, and delivers the uplink grant and the associated HARQ information to the HARQ entity for this TTI, if the NDI in the received HARQ information is 1.

If the NDI in the received HARQ information is 0, the MAC entity stores the uplink grant and the associated HARQ information as configured uplink grant, initialises (if not active) or re-initialise (if already active) the configured uplink grant to start in this TTI and to recur, considers the NDI bit for the corresponding HARQ process to have been toggled, and delivers the configured uplink grant and the associated HARQ information to the HARQ entity for this TTI.

There is one HARQ entity at the MAC entity for each Serving Cell with configured uplink, which maintains a number of parallel HARQ processes allowing transmissions to take place continuously while waiting for the HARQ feedback on the successful or unsuccessful reception of previous transmissions.

At a given TTI, if an uplink grant is indicated for the TTI, the HARQ entity identifies the HARQ processes for which a transmission should take place. It also routes the received HARQ feedback (ACK/NACK information), MCS and resource, relayed by the physical layer, to the appropriate HARQ processes.

For each TTI, the HARQ entity shall identify the HARQ process(es) associated with this TTI, and for each identified HARQ process: if an uplink grant has been indicated for this process and this TTI, if the received grant was not addressed to a Temporary C-RNTI on PDCCH and if the NDI provided in the associated HARQ information has been toggled compared to the value in the previous transmission of this HARQ process, the HARQ entity shall obtain the MAC PDU to transmit from the “Multiplexing and assembly” entity, deliver the MAC PDU and the uplink grant and the HARQ information to the identified HARQ process, and instruct the identified HARQ process to trigger a new transmission.

If the HARQ buffer of this HARQ process is not empty, the HARQ entity instructs the identified HARQ process to generate a non-adaptive retransmission.

Each HARQ process is associated with a HARQ buffer.

Each HARQ process shall maintain a state variable CURRENT_TX_NB, which indicates the number of transmissions that have taken place for the MAC PDU currently in the buffer, and a state variable HARQ_FEEDBACK, which indicates the HARQ feedback for the MAC PDU currently in the buffer. When the HARQ process is established, CURRENT_TX_NB shall be initialized to 0.

The sequence of redundancy versions is 0, 2, 3, 1. The variable CURRENT_IRV is an index into the sequence of redundancy versions. This variable is up-dated modulo 4.

New transmissions are performed on the resource and with the MCS indicated on PDCCH or Random Access Response. Adaptive retransmissions are performed on the resource and, if provided, with the MCS indicated on PDCCH. Non-adaptive retransmission is performed on the same resource and with the same MCS as was used for the last made transmission attempt.

The MAC entity is configured with a Maximum number of HARQ transmissions and a Maximum number of Msg3 HARQ transmissions by RRC: maxHARQ-Tx and maxHARQ-Msg3Tx respectively. For transmissions on all HARQ processes and all logical channels except for transmission of a MAC PDU stored in the Msg3 buffer, the maximum number of transmissions shall be set to maxHARQ-Tx. For transmission of a MAC PDU stored in the Msg3 buffer, the maximum number of transmissions shall be set to maxHARQ-Msg3Tx.

When the HARQ feedback is received for this TB, the HARQ process shall set HARQ_FEEDBACK to the received value.

If the HARQ entity requests a new transmission, the HARQ process shall set CURRENT_TX_NB to 0, set CURRENT_IRV to 0, store the MAC PDU in the associated HARQ buffer, store the uplink grant received from the HARQ entity, set HARQ_FEEDBACK to NACK, and generate a transmission as described below.

If the HARQ entity requests a retransmission, the HARQ process shall increment CURRENT_TX_NB by 1. If the HARQ entity requests an adaptive retransmission, the HARQ process shall store the uplink grant received from the HARQ entity, set CURRENT_IRV to the index corresponding to the redundancy version value provided in the HARQ information, set HARQ_FEEDBACK to NACK, and generate a transmission as described below. Else if the HARQ entity requests a non-adaptive retransmission, if HARQ_FEEDBACK=NACK, the HARQ process shall generate a transmission as described below. When receiving a HARQ ACK alone, the MAC entity keeps the data in the HARQ buffer.

To generate a transmission, the HARQ process shall instruct the physical layer to generate a transmission according to the stored uplink grant with the redundancy version corresponding to the CURRENT_IRV value, and increment CURRENT_IRV by 1 if the MAC PDU was obtained from the Msg3 buffer; or if there is no measurement gap at the time of the transmission and, in case of retransmission, the retransmission does not collide with a transmission for a MAC PDU obtained from the Msg3 buffer in this TTI.

If there is a measurement gap at the time of the HARQ feedback reception for this transmission and if the MAC PDU was not obtained from the Msg3 buffer, the HARQ process shall set HARQ_FEEDBACK to ACK at the time of the HARQ feedback reception for this transmission.

After performing above actions, the HARQ process then shall flush the HARQ buffer if CURRENT_TX_NB=maximum number of transmissions-1.

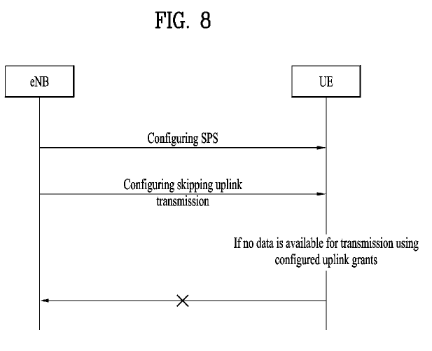

FIG. 8 is a diagram for configuring Semi-Persistent Scheduling and configuring skipping uplink transmission.

With current Semi-Persistent Scheduling (SPS), the eNodeB may configure SPS periodicity via dedicated RRC signalling. Current minimum SPS periodicity is 10 ms. Supporting a SPS periodicity of 1 TTI is beneficial as this may reduce the latency of initial UL transmissions. This would allow UL transmission in consecutive subframes.

In current specifications, the UE sends a MAC PDU containing a MAC CE for padding BSR and optionally padding bits in response to an allocated UL dynamic or configured grant even if no data is available for transmission in the UE buffer and no other regular MAC CE is needed to be sent. It is beneficial to allow UEs to skip (most) dynamic and configured uplink grants if no data is available for transmission. With frequent UL grants, allowing skipping UL grants may decrease UL interference and improve UE battery efficiency. The UE will continue to send one or more regular MAC CE(s), if any. The eNB may enable skipping UL grants by RRC dedicated signaling.

In skipping uplink transmission (SkipULTx), we need to see how retransmission can operate.

In latency reduction scope, the eNB is likely to configure a short SPS interval, e.g., 1 ms, or allocate dynamic UL grants for consecutive subframes (so called pre-scheduling period). Then, new transmission on a pre-scheduled resource via SPS or dynamic grant would collide with non-adaptive retransmission opportunity.

Currently, in a TTI, if there is an uplink grant for a new transmission, the UE cannot perform a non-adaptive retransmission. This implies that, in SkipULTx, the UE cannot perform a non-adaptive retransmission in a TTI even if the UE actually skips a new transmission in that TTI. In case the eNB pre-schedules resources for a long time, it means that the UE cannot perform the non-adaptive retransmission for a long time.

Moreover, as the eNB cannot tell whether the UE skips uplink transmission or the eNB fails at decoding, the eNB couldn't order an adaptive retransmission as well.

After the pre-scheduling period ends, the UE may be able to perform the retransmission. However, it may not be desirable to wait until when pre-scheduling period ends from the latency point of view. In addition, for the eNB and the UE to have the same Redundancy Version value, the UE/eNB may need to increment the Redundancy Version value even though the UE doesn't perform the retransmission. Then, counting maxHARQ-Tx may also need to be changed because incrementing Redundancy Version value and counting maxHARQ-Tx have been coupled so far.

One may think it would be good to allow for the UE to perform the non-adaptive retransmission on the pre-scheduled resource in case there is no data and the UE is to skip the uplink transmission on that pre-scheduled resource. However, this would make the eNB behaviour more complex because the eNB cannot know whether a new transmission, no transmission, or non-adaptive retransmission is performed on that pre-scheduled resource.

With above problems we expect in skipping uplink transmission, it seems that the current retransmission mechanism wouldn't work well with SkipULTx. Then, we may consider not to support retransmission at all with SkipULTx. Alternatively, in order to guarantee a reliable transmission with SkipULTx, we may consider an additional mechanism, e.g., performing a new transmission of a MAC PDU already stored in the HARQ buffer.

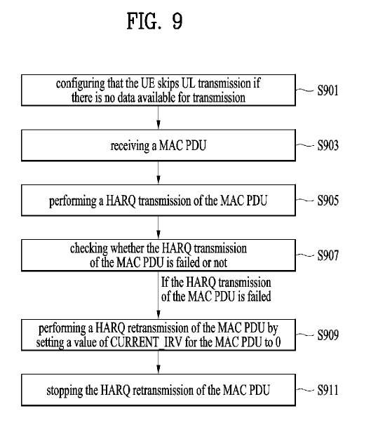

FIG. 9 is a conceptual diagram for transmitting a HARQ feedback in a wireless communication system according to embodiments of the present invention.

In this invention, it is proposed that a MAC entity performs an ACK-based HARQ transmission of a MAC PDU which is already stored in a HARQ buffer if the MAC entity considers the new HARQ transmission of the MAC PDU fails. In other words, if the new HARQ transmission of the MAC PDU is considered fail, the MAC entity does not perform HARQ retransmission of the MAC PDU but performs ACK-based HARQ transmission of the MAC PDU.

The UE configures that the UE skips an uplink transmission if there is no data available for transmission in the RLC or PDCP entities, under SPS is configured (S901). When the UE receives a MAC PDU (S903), the UE performs a HARQ transmission of the MAC PDU (S905).

When a MAC entity performs a new HARQ transmission, the MAC entity may set CURRENT_TX_NB to 0, set CURRENT_IRV to 0, and obtain a new MAC PDU from the Multiplexing and Assembly entity and store the MAC PDU in the associated HARQ buffer.

When the MAC entity performs a new HARQ transmission of a MAC PDU, the HARQ process stores the MAC PDU in the associated HARQ buffer and instructs the physical layer to generate a new HARQ transmission of the MAC PDU.

After the MAC entity performs the new HARQ transmission of the MAC PDU, the MAC entity checks whether the HARQ transmission of the MAC PDU is failed or not (S907).

The MAC entity shall consider the new HARQ transmission of the MAC PDU fails in the following cases: i) a positive acknowledgement is not received on a pre-determined subframe for the MAC PDU, or ii) a positive acknowledgement is not received until when a configured time duration has passed after the new HARQ transmission of a MAC PDU.

In case of i), the pre-determined subframe is decided based on a subframe where the new HARQ transmission of the MAC PDU is performed. For example, in FDD, 4 subframes after the new HARQ transmission of the MAC PDU.

Meanwhile, the MAC entity considers the new HARQ transmission of the MAC PDU successes in the following cases: i) a positive acknowledgement is received on a pre-determined subframe for the MAC PDU, or ii) a positive acknowledgement is received until when a configured time duration has passed after the HARQ process performs the new HARQ transmission of a MAC PDU.

When the UE performs a HARQ retransmission procedure of the MAC PDU by setting a value of CURRENT_IRV for the MAC PDU to 0 if the UE considers that the HARQ transmission of the MAC PDU is failed (S909).

The HARQ retransmission of the MAC PDU by setting a value of CURRENT_IRV for the MAC PDU to 0 is called as “ACK-based HARQ transmission”.

When the MAC entity performs ACK-based HARQ transmission, the MAC entity set the CURRENT_IRV to 0.

Under condition of skipping UL data transmission if there is no data available for transmission, when the UE intends to perform a retransmission by incrementing Redundancy Version value, the eNB cannot tell whether the UE skips uplink transmission or the eNB fails at decoding. That is, the eNB cannot tell whether the transmission is for a new transmission or a a retransmission. In this case, if the MAC entity performs the HARQ retransmission of the MAC PDU by setting a value of CURRENT_IRV for the MAC PDU to 0 according to the our invention, there can be no decoding errors for the eNB, because the eNB and the UE have the same Redundancy Version value.

In the step of S909, the HARQ retransmission is same as a legacy retransmission except setting a value of CURRENT_IRV for the MAC PDU to 0.

When a MAC entity performs an ACK-based HARQ transmission of a MAC PDU, the MAC entity increments CURRENT_TX_NB by 1 and keeps the MAC PDU already stored in the associated HARQ buffer, if the HARQ process performing the current ACK-based HARQ transmission and the HARQ process performing the last ACK-based HARQ transmission or the new HARQ transmission of the MAC PDU are same.

However, if the HARQ process performing the current ACK-based HARQ transmission and the HARQ process performing the last ACK-based HARQ transmission or the new HARQ transmission of the MAC PDU are different, the MAC entity moves the MAC PDU already stored in the HARQ buffer of the HARQ process performing the last ACK-based HARQ transmission or the new HARQ transmission of the MAC PDU to the HARQ buffer of the HARQ process performing the current ACK-based HARQ transmission.

When a MAC entity performs a legacy HARQ retransmission the MAC entity increments CURRENT_TX_NB by 1, updates CURRENT_IRV, and keeps the MAC PDU stored in the associated HARQ buffer.

Additionally, if the MAC entity considers that the last ACK-based HARQ transmission of the MAC PDU fails, i.e., the MAC entity keeps performing ACK-based HARQ transmission of the MAC PDU until when the ACK-based HARQ transmission of the MAC PDU successes, at that time, the MAC entity performs ACK-based HARQ transmission of a MAC PDU.

The MAC entity stops ACK-based HARQ transmission of a MAC PDU (S911) when: i) the CURRENT_TX_NB for the MAC PDU reaches the maximum value, or ii) the MAC entity receives a stop command from the eNB, or iii) the MAC entity discards the MAC PDU.

After the MAC entity performs the ACK-based HARQ transmission of the MAC PDU, the MAC entity shall consider the ACK-based HARQ transmission of the MAC PDU fails in the following cases: i) a positive acknowledgement is not received on a pre-determined subframe for the MAC PDU, or ii) a positive acknowledgement is not received until when a configured time duration has passed after the ACK-based HARQ transmission of a MAC PDU. The MAC entity shall considers the ACK-based HARQ transmission of the MAC PDU successes in the following cases: i) a positive acknowledgement is received on a pre-determined subframe for the MAC PDU, or ii) a positive acknowledgement is received until when a configured time duration has passed after the HARQ process performs the ACK-based HARQ transmission of a MAC PDU.

If the MAC entity considers that new HARQ transmission or ACK-based HARQ transmission of a MAC PDU fails, the MAC entity performs ACK-based HARQ transmission of the MAC PDU.

When the MAC entity considers that new HARQ transmission or ACK-based HARQ transmission of the MAC PDU fails, the MAC entity may perform followings: i) triggers a Scheduling Request, or ii) discards the MAC PDU, or iii) set HARQ_FEEDBACK for the HARQ process to ACK, or iv) indicates the new HARQ transmission failure of the RLC PDU(s) included in the MAC PDU to the RLC entity. The RLC performs RLC retransmission of the RLC PDU(s) indicated as HARQ transmission failure from the MAC entity.

Preferably, the MAC PDU can be any MAC PDU generated by the UE, or a MAC PDU containing a MAC SDU from a specific logical channel (e.g., logical channel with priority which is higher than a threshold), or a MAC PDU containing a specific MAC Control Element (e.g., PHR MAC CE or BSR MAC CE).

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by subsequent amendment after the application is filed.

In the embodiments of the present invention, a specific operation described as performed by the BS may be performed by an upper node of the BS. Namely, it is apparent that, in a network comprised of a plurality of network nodes including a BS, various operations performed for communication with an MS may be performed by the BS, or network nodes other than the BS. The term ‘eNB’ may be replaced with the term ‘fixed station’, ‘Node B’, ‘Base Station (BS)’, ‘access point’, etc.

The above-described embodiments may be implemented by various means, for example, by hardware, firmware, software, or a combination thereof.

In a hardware configuration, the method according to the embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, or microprocessors.

In a firmware or software configuration, the method according to the embodiments of the present invention may be implemented in the form of modules, procedures, functions, etc. performing the above-described functions or operations. Software code may be stored in a memory unit and executed by a processor. The memory unit may be located at the interior or exterior of the processor and may transmit and receive data to and from the processor via various known means.

Those skilled in the art will appreciate that the present invention may be carried out in other specific ways than those set forth herein without departing from essential characteristics of the present invention. The above embodiments are therefore to be construed in all aspects as illustrative and not restrictive. The scope of the invention should be determined by the appended claims, not by the above description, and all changes coming within the meaning of the appended claims are intended to be embraced therein.

### INDUSTRIAL APPLICABILITY

While the above-described method has been described centering on an example applied to the 3GPP LTE system, the present invention is applicable to a variety of wireless communication systems in addition to the 3GPP LTE system.

1. A method for a user equipment (UE) operating in a wireless communication system, the method comprising:
performing a Hybrid-ARQ (HARQ) transmission of a Medium Access Control (MAC) Protocol Data Unit (PDU) to an eNodeB (eNB) on a configured grant; and
performing a HARQ retransmission procedure of the MAC PDU, by setting a value of CURRENT_IRV for the MAC PDU to 0, if the UE considers that the HARQ transmission of the MAC PDU is failed, in a state that the UE skips an uplink transmission when there is no data available for transmission in a UE buffer.

2. (canceled)

3. The method according to claim 1, wherein when the UE performs one or more HARQ retransmissions during the HARQ retransmission procedure, the UE increments a value of CURRENT_TX_NB for the MAC PDU by 1, per HARQ retransmission.

4. The method according to claim 3, wherein the UE stops the HARQ retransmission procedure of the MAC PDU,
when the value of CURRENT_TX_NB for the MAC PDU reaches a maximum value; or
when the MAC entity receives a stop command from the eNB; or
when the MAC entity discards the MAC PDU in an associated HARQ buffer.

5. (canceled)

6. The method according to claim 1, wherein when a positive acknowledgement is not received on a pre-determined subframe for the MAC PDU, or a positive acknowledgement is not received until when a configured time duration has passed after the HARQ transmission of the MAC PDU, the UE considers that the HARQ transmission of the MAC PDU is failed.

7. The method according to claim 1, wherein the MAC PDU is a MAC PDU including a MAC Service Data Unit (SDU) from a specific logical channel, or a MAC PDU including a specific MAC Control Element (CE).

8. A User Equipment (UE) for operating in a wireless communication system, the UE comprising:
a Radio Frequency (RF) module; and
a processor operably coupled with the RF module and configured to:
perform a Hybrid-ARQ (HARQ) transmission of a Medium Access Control (MAC) Protocol Data Unit (PDU) to eNodeB (eNB), and
check whether the HARQ
perform a HARQ retransmission procedure of the MAC PDU, by setting a value of CURRENT_IRV for the MAC PDU to 0, if the UE considers that the HARQ transmission of the MAC PDU is failed, in a state that the UE skips an uplink transmission when there is no data available for transmission in a UE buffer.

9. (canceled)

10. The UE according to claim 8,
wherein when the processor performs one or more HARQ retransmissions during the HARQ retransmission procedure, the processor increments a value of CURRENT_TX_NB for the MAC PDU by 1, per HARQ retransmission.

11. The UE according to claim 10,
wherein the processor stops the HARQ retransmission procedure of the MAC PDU,
when the value of CURRENT_TX_NB for the MAC PDU reaches a maximum value; or
when the MAC entity receives a stop command from the eNB; or
when the MAC entity discards the MAC PDU in an associated HARQ buffer.

12. (canceled)

13. The UE according to claim 8, wherein when a positive acknowledgement is not received on a pre-determined subframe for the MAC PDU, or a positive acknowledgement is not received until when a configured time duration has passed after the HARQ transmission of the MAC PDU, the processor considers that the HARQ transmission of the MAC PDU is failed.

14. The UE according to claim 8, wherein the MAC PDU is a MAC PDU including a MAC Service Data Unit (SDU) from a specific logical channel, or a MAC PDU including a specific MAC Control Element (CE).

15. The method according to claim 1, wherein the UE buffer includes at least one of Radio Link Control (RLC) buffer or a Packet Data Convergence Protocol (PDCP) buffer.

16. The UE according to claim 8, wherein the UE buffer includes at least one of a Radio Link Control (RLC) buffer or a Packet Data Convergence Protocol (PDCP) buffer.
